(19) United States
(12) Patent Application Publication
(10) Pub. No.: US 2005/0287254 A1
(43) Pub. Date: Dec. 29, 2005

(54) Apparatus and methods for food processing

(76) Inventor: Peter V. Radatti, Conshohocken, PA (US)

Correspondence Address: Peter V. Radatti, 1508 Butler Pike, Conshohocken, PA, 19428, US

(21) Appl. No.: 10/876,907

(22) Filed: Jun. 25, 2004

(51) Int. Cl. C12H 1/06

(52) U.S. Cl. 426/238

(57) ABSTRACT

The present invention is related to apparatus and methods for food processing using nonthermal sterilization methods. A frequency generator generates a pathogen specific modulation frequency which is modulated onto a carrier wave by a radio frequency generator resulting in an output signal. The output signal is then amplified and output via an antenna for radiation of a food.

### FIELD OF THE INVENTION

The present invention is related to apparatus and methods for food processing. More particularly, the present invention is related to apparatus and methods for food processing using nonthermal sterilization methods.

### BACKGROUND OF THE INVENTION

Thermal methods, such as heating or freezing, have traditionally been used to sterilize foods. Sterilization includes destroying insects, fungi, bacterial pathogens or other undesirable organic or inorganic matter, and is used in order to prevent spoilage or illness prior to ingestion, or for other reasons as desired.

There are numerous difficulties with thermal methods. For example, applying heat to foodstuffs may unfavorably and/or undesirably affect taste, texture, nutrients, color and other quantities of the foodstuff.

Thus, alternative, nonthermal methods of sterilization exist, but generally each has difficulties. For example, chemical sterilization methods exist, that is using chemicals to sterilize foodstuffs, but safety and/or health concerns have limited the use of these methods. Mechanical methods, such as pressurization (that is, applying high pressure directly to the food stuff) but the food needs to be submerged in a substance, such as liquid, though which the pressure can be applied, which may cause difficulties with the food after pressurization. Moreover, not all foods can undergo pressurization treatment because of the need for submersion. Surface radiation methods, using pulsed light, can only be used to treat the surfaces of foods such as fruit and the like. Radioisotope radiation may be used as well, however, radioisotope radiation requires containers or compartments to confine the beams so that personnel won't be exposed. Radioisotope radiation is also presently somewhat controversial.

Accordingly, it would be helpful to provide improved apparatus and methods for food processing.

### SUMMARY OF THE INVENTION

The present invention provides apparatus and methods for food processing using nonthermal sterilization methods. Embodiments may be used to sterilize food preparation surroundings as well, so that pathogens are not transferred inadvertently to foodstuffs post sterilization. Additionally, certain embodiments may be used to treat organic and non organic matter which are subsequently provided as foodstuffs.

Preferred embodiments use a frequency generator to provide one or more frequencies to a radio frequency generator, which in turn modulates the frequency onto a carrier wave. The carrier wave is then amplified and output via an antenna. Thus food stuffs are irradiated with audio, radio, and light waves.

### BRIEF DESCRIPTION OF THE DRAWINGS

FIG. 1 shows a preferred embodiment.

### DETAILED DESCRIPTION OF THE PREFERRED EMBODIMENTS

The preferred embodiments provide for food sterilization through radiating foodstuffs with electromagnetic fields and/or sound waves at various predetermined frequencies. Sound wave irradiation embodiments use frequencies in the supersonic range. Both method and apparatus embodiments are described below.

Various pathogens are killed or rendered inactive through irradiation according to the preferred embodiments. Those pathogens include pathogenic bacteria such as: Aeromonas hydrophila, Bacillus cereus, Campylobacter jejuni, Clostridium botulinum, Clostridium perfringens, pathogenic Escherichia coli, Listeria monocytogenes, Salmonella, Shigella, Staphylococcus aureus, pathogenic Vibrio spp. and Yersinia enterocolitica known to be responsible for causing food borne disease; enteric viruses such as Hepatitis A, Norwalk, Norwalk-like and Rotavirus; and parasites such as Cryptosporidium parvum, Cyclospora cayetanensis, Giardia lamblia and Toxoplasma gondii which often produce resistant cysts.

As will be further described below, various preferred embodiments may be readily tuned to be pathogen specific, while not affecting the food stuff that is being treated. In other words, unlike prior art techniques such as heat, where the food is affected (heated) in order to kill or inactivate pathogens, various preferred embodiments may affect only the pathogen, and have little if any impact upon the food itself.

Although the pathogens listed above are probably the most common, others may be killed or rendered inactive as well by various embodiments. In general, the preferred embodiments kill or render inactive various pathogens including food microbial hazards such as bacteria, including pathogenic and spoilage bacteria; yeasts; molds; parasites and protozoa, as well as active vegetative cells and spores. For example, in meat, poultry, etc. pathogens such as Salmonella, Clostridium botulinum, and Trichinae may be destroyed; in perishable foods contaminants such as mold may be destroyed; in grains, fruits and vegetables, insects may be destroyed; in juices, yeast may be destroyed, etc.

Additionally, various preferred embodiments may be used to sterilize food preparation surroundings such as food preparation areas, butchering areas, etc. as well as nonfood animal and other substances, which often contains bacteria that may be transferred to the food during processing (e.g., hide, hair, general contaminants, fecal matter, etc.)

Sterilization is used here to designate the killing or inactivation of various pathogens according to generally recognized measurements, such as: measuring microbial reduction kinetics post-sterilization; using surrogates as is known in the art; etc.

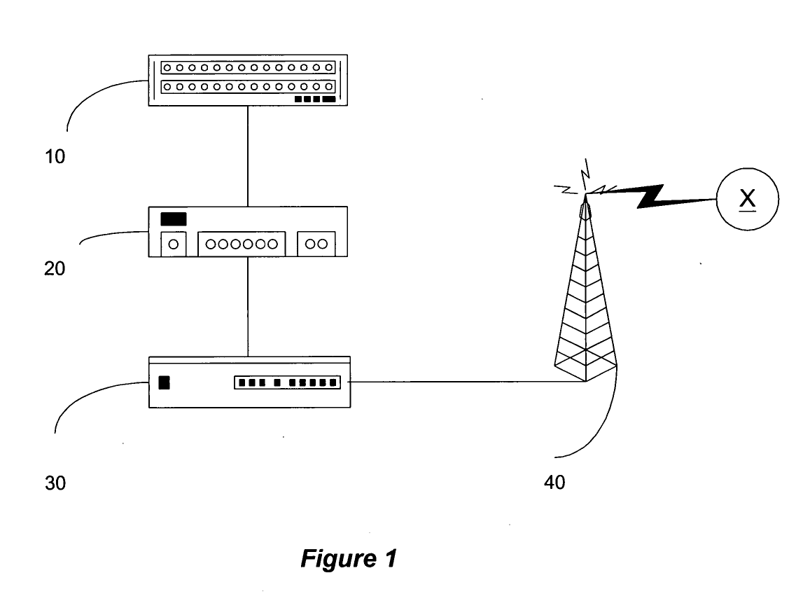

FIG. 1 shows a preferred embodiment. A frequency generator 10 provides signals of desired frequency or frequencies to a RF (radio frequency) generator 20. The signal or signals generated by frequency generator 10, referred to hereinafter as modulation frequency or frequencies, may be any desired frequency, although generally frequencies in the range of 2 kHz to 200 kHz are used. Additionally, in some embodiments, dithering or other means may provide for variant frequencies about a base sterilization frequency. For example, frequencies may vary in range up to ten percent and more about their frequency setting because of dithering.

Generally signals are provided by frequency generator 10 through a square wave, rather than a sine or other wave, although other waves may be used as desired. Use of a square wave provides an infinite series of harmonics (of the frequency generator-generated frequency) which is generally desirable in the preferred embodiments, although in other embodiments it may be desired to use other forms of infinite harmonics, and/or non-infinite series of harmonics and/or a pure wave, in addition to or in place of a square wave.

RF generator 20 modulates the signal received from frequency generator 10 onto a carrier wave through amplitude modulation. In the preferred embodiments, the carrier wave or waves operate at a desired frequency or frequencies. A range of carrier wave frequencies may be provided, for example, 2 MHz to 40 MHz, with the actual frequency or frequencies set as desired, for example, 3.3 MHz, 4.6 MHz, etc. The carrier waves are also provided, in the preferred embodiments, with a variable bandwidth. Thus output may be along a consistent, predetermined bandwidth, may be varied, etc.

The modulation onto the carrier wave by the RF generator results in an output signal. In the preferred embodiments, this output signal is pulsed. The duration and other parameters of the pulse may be varied if desired, using means as known in the art, with the pulse frequency being as desired. For example, 4 MHz pulses might be used, 60 MHz pulses, etc. Pulsing may also be due in whole or part to a function of the wave form used. For example, a square wave or other wave forms will lead to pulsing due to the nature of their form.

The pulsed output signal is fed to an antenna 40 via an amplifier 30, preferably a linear amplifier. In certain preferred embodiments, this is a plasma antenna. As impedances may vary according to the frequency or frequencies or other variables, a tuner may be used to match impedances in order to decrease power loss or any other undesired characteristics. It should be noted that such a tuner may need to match impedances dynamically, insofar as a plasma antenna may have changing impedances in the course of its operation.

As was noted immediately above, antenna 40 is a plasma antenna in certain preferred embodiments. The output of antenna 40 comprises a wave, which may be audio, radio, light and/or waves. If a plasma antenna is used, the output may be audio, radio, light and/or plasma waves as well, but in certain preferred embodiments is at least electromagnetic waves, (i.e. radio and light waves, hereinafter “output wave” or “output waves.”) For example, with a plasma antenna in certain preferred embodiments, the output waves will be audio, radio and light as well as a plasma wave or waves.

The frequencies of these output waves may change according to various electrical characteristics of the input, e.g., frequenc(ies) of the signals generated by the frequency generator 10, frequenc(ies) of the carrier wave(s), voltage, current and/or power level applied to various components, etc. Frequencies may also change according to other variables. For example, mechanical characteristics such as length of the plasma antenna, etc. may affect frequency. Accordingly, it may be desired to use, at various places in various embodiments, sampling mechanisms, e.g., feedback loops, etc. to confirm desired output, etc.

The power output to the antenna varies. For example, the nature of the substance to be sterilized; the nature of the pathogen; the distance from the antenna to the substance to be sterilized, etc. may all require modifications to power output to the antenna, which will result in turn in a variable strength antenna output wave. Generally, in the especially preferred embodiments, 50 to 250 watts provides the range for power output from the linear amplifier 30 to the antenna 40.

It should be noted that the pulsed output signal provided to antenna 40 will result in antenna 40 broadcasting the modulated frequency in pulses. Modulation pulse frequency may be set as desired. It may also be a function of input. For example, increasing frequency from the frequency generator 10 may result in a shorter and more frequent output pulse. Similarly, decreasing frequency may result in a longer and less frequent output pulse. If desired, a gating or other mechanism may be interposed in order to control the output pulse. The length and frequency of the pulsed antenna broadcast may affect sterilization intensity and thus it may be desired to control the pulse, for example, using a gating mechanism, etc.

If a plasma antenna is used, the gas to be excited into a plasma may be present in a quartz, glass, or other substance sufficient to contain the stress, container. It is thought that the container itself may vibrate as a result of the plasma, and thus, audio or other waves are created through the vibration. If a non containerized plasma antenna or other antenna is used, it may be desired to provide a resonating reflector or other device, to provide additional audio or other waves.

Plasma antenna variables include types of gases, types of gas mixes, volumes of gas or gases, as well as antenna shapes. For example, linear antennas, bubble shaped or other protrusion type antennas, (including single, double, triple bubbles, etc.) may be used in preferred embodiments. Direct, induction, and other methods may be used to ignite and sustain a plasma antenna, as well as combination methods, for example, using direct ignition for initial lighting and induction to sustain lighting, using induction to ignite and direct to sustain, using induction to light and sustain, etc.

Antennas may be shaped and sized as desired. For example, certain antenna shapes and/or sizes may be especially efficient in transmitting certain frequencies. As another example, certain antenna shapes and/or sizes may be more useful in radiating certain food stuffs, e.g., a certain shape may be easier to use with certain cuts of meat as opposed to certain types of fruit.

One or more antennas may be used as well. For example an antenna array may be used. Preferred embodiments use antennas in phased array arrangements, with the distance between the antennas of the array determined by the frequencies of the antennas. Thus, interference is reduced between antennas.

Returning now to FIG. 1, the output wave of antenna 40 is shown irradiating food X. The output wave emitted by antenna 40 is tuned according to a pathogen specific modulation frequency. This pathogen specific frequency is determined in the preferred embodiments by irradiating a pathogen in a controlled environment and determining what modulation frequencies may destroy or incapacitate the pathogen.

It should be noted that the use of various embodiments in various environments and with various substances may require retuning—that is, the output waves may or may not be affected by the environment in which they are operating or the substance they are operating on. Thus, fine tuning may be necessary to compensate for these conditions. Other factors that may affect fine tuning include but are not limited to: desired electric field intensity, pulse width, treatment time and temperature, and pulse wave shapes; as well as various pathogen characteristics (type and form, genus, species and strain concentration, and growth stage of microorganisms), and any environmental variables, such as treatment media (pH, antimicrobials, ionic compounds, etc.) conductivity, and ionic strength; distance, other RF, EM or audio waves present, etc.

In some embodiments, there may be an enclosure or sterilization chamber, as desired.

The time period of the irradiation may be as desired. In various preferred embodiments, a range of frequencies is applied to the food stuff in order to eliminate any and all pathogens that may be present. The range is applied according to desired time parameters via manual or automated control.

Automated control is present in the especially preferred embodiments, so that foods may be irradiated across the frequency spectrum without manual intervention, which is especially useful in commercial production. Parameters are set for particular foods, so pathogens appropriate to that food are destroyed. So, for example, embodiments used in the treatment of beef may have one or more automated radiation ranges that are different than an embodiment used to treat fruit.

It should be noted that various embodiments may be used at various levels of amplification in order to increase the range of the waves. So, for example, a power level may be desirably set so as to ensure that entire or partial penetration of the food stuff is accomplished, if desired, or set so that radiation occurs only at the surface of the food. Of course, any desired power levels may be set, e.g., a range of power levels may be set as well, so that radiation occurs at surface as well as at various penetration levels, as well as for near field or far field uses, etc. Generally, in most embodiments, the power is set below possible thermal radiation and/or effects.

In preferred embodiments, as was described above, the wave is pulsed through a square shaped wave form. This causes an increased/decreased radiation of the modulation frequency from antenna 40, which is believed to increase sterilization effects. The on cycle may be the same or other length as the off cycle. In other embodiments, other wave shapes may be used as desired.

Once the appropriate frequency is applied for an appropriate period of time, the pathogen is destroyed. While not intending to be bound by theory, it is believed that the output wave causes, though conduction, resonant frequencies in the pathogen's structure, so as to destroy the pathogen. For example, if the pathogen is bacterial, the output wave causes membrane resonance, which leads to electroporation or membrane destruction. Without a functioning membrane, the cell dies.

It may be possible to render inactive (which includes destroy) proteins or other agents (hereinafter “undesired agents”) present in food as well, using modulation frequencies appropriate to render the undesired agents inactive by, for example, breaking a protein chain, structurally modifying the undesired agent, etc. For example, meat or other food stuffs may be rendered inedible by undesirable protein structures. Thus, by using output waves appropriate to the resonant frequency of destruction for said protein structures, those structures could be destroyed, and so meat rendered edible. As another example, proteins or other agents may be implicated in disease causation, e.g., ingestion of bovine spongiform encephalopathy-contaminated beef may cause variant Creutzfeldt-Jakob disease. Thus radiation at appropriate frequency modulation would sterilize food through inactivation of materials causing undesirable structural or other characteristics.

Insofar as pathogens may be present in or on food stuffs where they may not be accessed by output waves, additional methods to agitate and/or oscillate food stuffs may be used. For example, ultrasonic or other methods may be used to agitate and/or oscillate the pathogens to the surface of the food stuff. This provides greater radiation of the pathogens by output waves.

Other embodiments may use, in the place of an antenna, electrodes to be applied to a food stuff. These electrodes provide pathogen specific modulated current directly to the food, which, it is believed, cause resonant structural destruction.

The above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

1) A device for sterilizing food, comprising:
a frequency generator,
a radio frequency generator,
an amplifier, and,
an antenna,
whereby said frequency generator provides a signal of a desired frequency to said radio frequency generator, which modulates said signal onto a carrier wave, which is amplified via said amplifier and output via said antenna in the form of audio, radio and light waves, and where said waves radiate a food to be sterilized.

2) A device as in claim 1 wherein said antenna further comprises a plasma antenna.

3) A device as in claim 1 further comprising a tuner, to match impedances between said amplifier and said antenna.

4) A device as in claim 2 wherein said output further comprises a plasma wave.

5) A device as in claim 1 wherein said antenna further comprises an antenna array.

6) A device as in claim 5 wherein said antenna further comprises a phased antenna array.

7) A device as in claim 1 further comprising a sampling mechanism.

8) A device as in claim 7 wherein said sampling mechanism further comprising a feedback loop for confirming desired output.

9) A device as in claim 1 wherein said signal of said desired frequency is a pathogen specific modulation frequency.

10) A method for sterilizing food comprising exposing said food to nonthermal radiation which is further comprised of audio, radio and light waves and wherein said nonthermal radiation is determined according to a pathogen specific modulation frequency.

11) A method as in claim 10 further comprising exposing said food to nonthermal radiation which is further comprised of plasma waves.

12) A method for treating food comprising:
determining a pathogenic specific modulation frequency;
providing said pathogen specific frequency to an antenna;
radiating, from said antenna a wave with frequency characteristics determined from said pathogen specific frequency.

13) A method for treating food comprising:
generating a pathogen specific modulation frequency;
modulating said pathogen specific modulation frequency onto a carrier wave resulting in a output signal;
amplifying said output signal;
broadcasting said output signal, as a combination of audio, radio and light waves, and so irradiating a food to be sterilized.

14) A method for treating food preparation areas comprising:
generating a pathogen specific modulation frequency;
modulating said pathogen specific modulation frequency onto a carrier wave resulting in an output signal;
amplifying said output signal;
broadcasting said output signal, as a combination of audio, radio and light waves, and so irradiating a food preparation area.

15) A method as in claim 13 wherein said carrier wave is between 2 MHz to 40 MHz.

16) A method as in claim 13 wherein generating a pathogen specific modulation frequency further comprises generating a generating a pathogen specific modulation frequency in the form of a square wave.

17) A method as in claim 13 wherein modulating said pathogen specific modulation frequency onto a carrier wave resulting in an output signal further comprises modulating said pathogen specific modulation frequency onto a carrier wave resulting in a pulsed output signal.

18) A method as in claim 13 wherein broadcasting said output signal, as a combination of audio, radio and light waves, further comprises broadcasting said output signal, as a combination of audio, radio, light and plasma waves.

19) A method as in claim 13 further comprising sampling said output signal.

20) A method as in claim 13 wherein said output signal is amplified to a power level of between 50 to 250 watts.

21) A method as in claim 13 wherein broadcasting of said output signal occurs via an antenna array.

22) A method as in claim 21 wherein said antenna array further comprises a phased antenna array.

23) A method as in claim 13 further comprising broadcasting a range of frequencies.

24) A method as in claim 23 further comprising automatically controlling said range of frequencies.

25) A method as in claim 13 further comprising determining pathogen specific modulation frequencies appropriate to a specific food.

26) A method as in claim 13 further comprising determining pathogen specific modulation frequencies.

27) A method for sterilizing food comprising exposing said food to nonthermal radiation which is further comprised of audio, radio and light waves and wherein said nonthermal radiation is determined according to a modulation frequency appropriate to undesired agents.

28) A method for treating food comprising applying electrodes to a food, wherein said electrodes transmit a pathogen specific modulated current.
